(19) United States
(12) Patent Application Publication
(10) Pub. No.: US 2009/0282429 A1
(43) Pub. Date: Nov. 12, 2009

(54) VIEWER TRACKING FOR DISPLAYING THREE DIMENSIONAL VIEWS

(75) Inventors: Stefan Olsson, Lund (SE); Orjan Percy, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/116,311

(22) Filed: May 7, 2008

(51) Int. Cl. H04H 60/33; G06K 9/00

(52) U.S. Cl. 725/10; 382/103

(57) ABSTRACT

A device may track one or more viewers, and determine, for each of the one or more viewers, a location of the viewer in accordance with the tracking. In addition, the device may determine, for each of the one or more viewers, a stereoscopic image that is to be viewed at the location, the stereoscopic image consisting of a right-eye image and a left-eye image. Further, the device may control display settings of a display to provide, via the display, each of the one or more viewers with the stereoscopic image associated with the viewer.

### BACKGROUND

A three-dimensional (3D) display may provide a stereoscopic effect (e.g., an illusion of depth) by rendering two slightly different images, one image for the right eye (e.g., a right-eye image) and the other image for the left eye (e.g., a left-eye image) of a viewer. When each of the eyes sees its respective image on the display, the viewer may perceive a stereoscopic image.

### SUMMARY

According to one aspect, a method may include tracking one or more viewers. and, determining, for each of the one or more viewers, a location of the viewer in accordance with the tracking. In addition, the method may further include determining, for each of the one or more viewers, a stereoscopic image that is to be viewed by the viewer at the location, the stereoscopic image consisting of a right-eye image and a left-eye image. Further, the method may further include controlling display settings of a display to provide, via the display, each of the one or more viewers with the stereoscopic image associated with the viewer.

Additionally, the method may further include providing, via the display, each of the one or more viewers with the stereoscopic image associated with the viewer.

Additionally, tracking may include tracking a head of each of the one or more viewers to determine a location of a right eye of the head.

Additionally, tracking one or more viewers may include tracking two viewers.

Additionally, determining a stereoscopic image may include determining a projection of a virtual, three-dimensional object, which is stored in a memory of a device, onto a surface of the display, to obtain the right-eye image. Determining a stereoscopic image may include obtaining the right-eye image from stored, three-dimensional multimedia content.

Additionally, controlling display settings may include adjusting a light guide to direct light rays from a picture element of the right-eye image on a surface of the display to the right eye and not to the left eye.

Additionally, the method may further include displaying, on the display, the right-eye image via a first set of sub-pixels that are visible to the right eye, and the left-eye image via a second set of sub-pixels that are visible to the left eye.

Additionally, the method may further include displaying, on the display, the right-eye image via sub-pixels, directing light rays from the sub-pixels to the right eye, displaying, on the display, the left-eye image via the sub-pixels, and directing light rays from the sub-pixels to the left-eye.

Additionally, the method may further include displaying, on the display, one of a plurality of stereoscopic images via sub-pixels, directing light rays from the sub-pixels to a first one of the viewers and not other ones of the viewers, displaying, on the display, another one of the plurality of stereoscopic images via the sub-pixels, and directing light rays from the sub-pixels to a second one of the viewers and not other ones of the viewers.

According to another aspect, a device may include a sensor for tracking a viewer, a display, and a processor. The display may include pixels and light guides, each light guide configured to direct light rays from a first sub-pixel within a pixel and a second sub-pixel within the pixel to a right eye and a left eye, respectively, of the viewer. The processor may be configured to obtain a location of the viewer based on output of the sensor, and determine a stereoscopic image that is to be viewed at the location, the stereoscopic image consisting of a right-eye image and a left-eye image. In addition, the processor may be further configured to display the right-eye image for viewing by the right eye via a first set of sub-pixels and the left-eye image for viewing by the left eye via a second set of sub-pixels.

Additionally, the processor may be further configured to drive the display to provide the stereoscopic image to the viewer when the stereoscopic image is displayed on the display.

Additionally, the device may include at least one of a laptop, a cell phone, a personal computer, a personal digital assistant, or a game console.

Additionally, the sensor may include at least one of an ultrasonic sensor, an infrared sensor, a camera sensor, or a heat sensor.

Additionally, the light guide may include a lenticular lens or a parallax barrier.

Additionally, the parallax barrier may be configured to modify a direction of a light ray from the first sub-pixel based on the location of the viewer.

Additionally, the right-eye image may include an image obtained from three-dimensional multimedia content, or a projection of a three-dimensional virtual object onto the display.

Additionally, the light guide may be further configured to redirect light rays from the first sub-pixel to the left eye of the viewer when a new image element is displayed by the first sub-pixel.

Additionally, the light guide may be further configured to redirect light rays from the second sub-pixel to a left eye of another viewer when a new image element is displayed by the second sub-pixel.

Additionally, the sensor may include a mechanism for locating the left eye and the right eye of the viewer.

According to yet another aspect, a device may include means for tracking a head of a viewer, means for displaying three-dimensional images, means for obtaining a location of the viewer based on output of the means for tracking the head, means for obtaining a three-dimensional image that is to be viewed at the location, and means for displaying the three-dimensional image.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 is a diagram illustrating an overview of a three-dimensional (3D) system in which concepts described herein may be implemented;

FIG. 2 is a diagram of the exemplary 3D system of FIG. 1;

FIGS. 3A and 3B are front and rear views of one implementation of an exemplary device of FIG. 1;

FIG. 4 is a block diagram of components of the exemplary device of FIG. 1;

FIG. 5 is a functional block diagram of the exemplary device of FIG. 1;

FIG. 6A shows an exemplary projection of a 3D object onto a 3D display for the left eye of a viewer;

FIG. 6B shows an exemplary projection of a 3D object onto a 3D display for the right eye of the viewer;

FIG. 7 is a flow diagram of an exemplary process for displaying 3D views based on head tracking;

FIG. 8 is a diagram illustrating operation of another implementation of the device of FIG. 1; and

FIG. 9 shows a scenario that illustrates the process of FIG. 7.

### DETAILED DESCRIPTION

The following detailed description refers to the accompanying drawings. The same reference numbers in different drawings may identify the same or similar elements.

### Overview

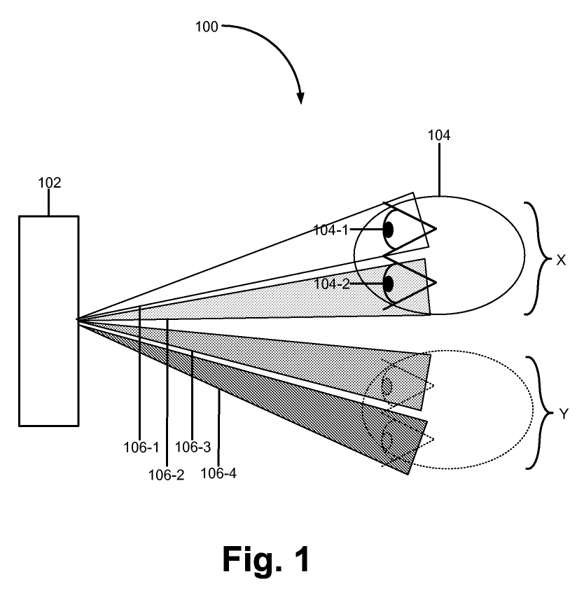

Aspects described herein provide a visual three-dimensional (3D) effect based on viewer tracking. FIG. 1 is a simplified diagram of an exemplary 3D system 100 in which concepts described herein may be implemented. As shown, 3D system 100 may include a device 102 and a viewer 104. Device 102 may generate and provide two-dimensional (2D) or 3D images to viewer 104 via a display. When device 102 shows a 3D image, viewer 104 in location X may receive a right-eye image and a left-eye image via light rays 106-1 and 106-2. Light rays 106-1 and 106-2 may carry different visual information, such that, together, they provide a stereoscopic image to viewer 104.

When viewer 104 moves from location X to location Y, for device 102 to maintain the impression that viewer 104 is looking at a 3D object, device 102 may need to convey, to viewer 104 at location Y, new right- and left-eye images of the 3D object that was viewed at location X. To accomplish the preceding, device 102 may track viewer 104's location using sensors. When device 102 detects that viewer 104 has moved from location X to location Y, device 102 may generate and send new right- and left-eye images via light rays 106-3 and 106-4.

In the above, instead of pre-computing the right-eye and left-eye images for many different viewing positions/angles, device 102 may track viewer 104 and generate the right-eye and left-eye images based on viewer 104's location at a particular time. By dynamically generating the images based on viewer 104's location, device 102 may save processing cycles, power, and/or memory that may be needed to pre-compute the images.

### Exemplary 3D System

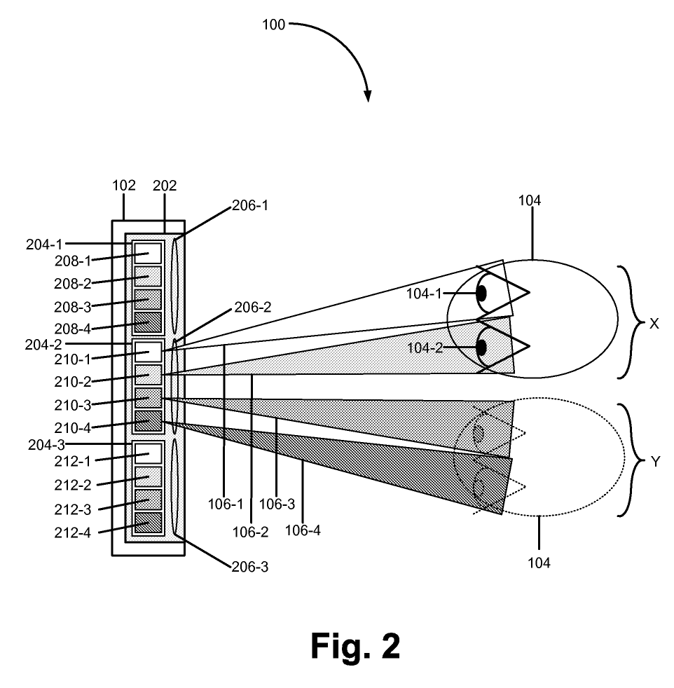

FIG. 2 is an exemplary diagram of the 3D system of FIG. 1. As shown in FIG. 2, 3D system 100 may include device 102 and viewer 104. Device 102 may include any of the following devices that have the ability to or are adapted to display 2D and 3D images, such as a radiotelephone or a mobile telephone with a 3D display; a personal communications system (PCS) terminal that may combine a 3D display with data processing, facsimile, data communications capabilities; an electronic notepad, a laptop, and/or a personal computer with a 3D display; a personal digital assistant (PDA) that can include a 3D display; a gaming device or console with a 3D display; a peripheral (e.g., wireless headphone, wireless display, etc.); a digital camera; or another type of computational or communication device with a 3D display, etc.

As further shown in FIG. 2, device 102 may include a 3D display 202. 3D display 202 may show 2D/3D images that are generated by device 102. Viewer 104 in location X may perceive light rays through a right eye 104-1 and a left eye 104-2.

As also shown in FIG. 2, 3D display 202 may include picture elements (pixels) 204-1, 204-2, and 204-3 (hereinafter collectively referred to as pixels 204) and light guides 206-1, 206-2, and 206-3 (herein collectively referred to as light guides 206). Although 3D display 202 may include additional pixels, light guides, or different components (e.g., a circuit for receiving signals from a component in device 102). Such components are not illustrated in FIG. 2 for the sake of simplicity.

In 3D display 202, pixel 204-2 may generate light rays 106-1 through 106-4 (herein collectively referred to as light rays 106 and individually as light ray 106-x) that reach viewer 104 via light guide 206-2. Light guide 206-2 may guide light rays 106 from pixel 204-2 in specific directions relative to the surface of 3D display 202.

As further shown in FIG. 2, pixel 204-2 may include sub-pixels 210-1 through 210-4 (herein collectively referred to as sub-pixels 210 and individually as sub-pixel 210-x). In a different implementation, pixel 204-2 may include fewer or additional sub-pixels.

To show a 3D image on 3D display 202, sub-pixels 210-1 through 210-4 may generate light rays 106-1 through 106-4, respectively. When sub-pixels 210 generate light rays 106, light guide 206-2 may direct each of light rays 106 on a path that is different from the paths of other rays 106. For example, in FIG. 2, light guide 206-2 may guide light ray 106-1 from sub-pixel 210-1 toward right-eye 104-1 of viewer 104 and light ray 106-2 from sub-pixel 210-2 toward left-eye 104-2 of viewer 104.

In FIG. 2, pixels 204-1 and 204-3 may include similar components as pixel 204-2 (e.g., sub-pixels 208-1 through 208-4 and sub-pixels 212-1 through 212-4), and may operate similarly as pixel 204-2. Thus, right-eye 104-1 may receive not only light ray 106-1 from sub-pixel 210-1 in pixel 204-2, but also light rays from corresponding sub-pixels in pixels 204-1 and 204-3 (e.g., sub-pixels 208-1 and 212-1). Left-eye 104-2 may receive not only light ray 106-2 from sub-pixel 210-2 in pixel 204-2, but also light rays from corresponding sub-pixels in pixels 204-1 and 204-3 (e.g., sub-pixels 208-2 and 212-2).

In the above, if a right-eye image of a stereoscopic image is displayed via sub-pixels 208-1, 210-1 and 212-1, and a left-eye image is displayed via sub-pixels 208-2, 210-2, and 212-2, right-eye 104-1 and left-eye 104-2 may see the right-eye image and the left-eye image, respectively. Consequently, viewer 104 may perceive a stereoscopic image at location X.

In FIG. 2, when viewer 104 moves from location X to location Y, for 3D display 202 to maintain the illusion that viewer 104 is viewing a 3D object, 3D display 202 may need to display right- and left-eye images that represent different perspectives of the 3D object than those that would be perceived by viewer 104 at location X. To accomplish the preceding, device 102 may track viewer 104 via sensors, and when device 102 detects that viewer 104 has moved from location X to location Y, device 102 may retrieve or dynamically generate a right-eye and left-eye images, and cause 3D display 202 to show the right-eye and left-eye images. For example, in FIG. 2, when viewer 104 is at location Y, device 102 may cause sub-pixels 208-3, 210-3, and 212-3 to display a new right-eye image, and sub-pixels 208-4, 210-4, and 210-4 to display a new left-eye image.

### Exemplary Device

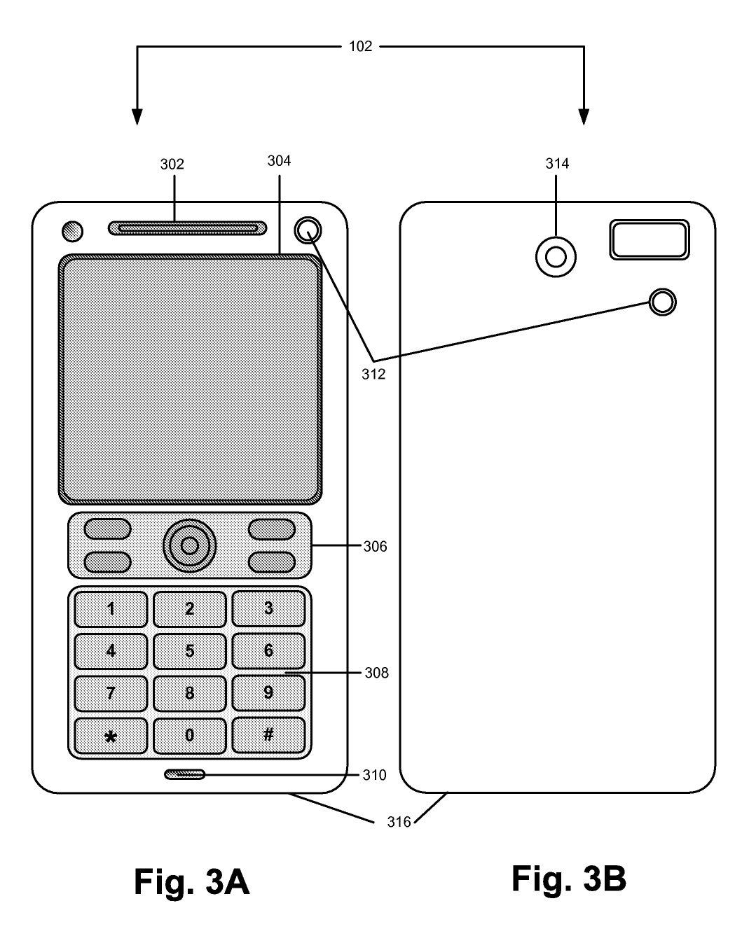

FIGS. 3A and 3B are front and rear views, respectively, of one implementation of device 102. In this implementation, device 102 may take the form of a portable phone (e.g., a cell phone). As shown in FIGS. 3A and 3B, device 102 may include a speaker 302, a display 304, control buttons 306, a keypad 308, a microphone 310, sensors 312, a lens assembly 314, and housing 316.

Speaker 302 may provide audible information to a user of device 102. Display 304 may provide two-dimensional or three-dimensional visual information to the user. Examples of display 304 may include an auto-stereoscopic 3D display, a stereoscopic 3D display, a volumetric display, etc. Display 304 may include pixel elements that emit different light rays to viewer 104's right eye 104-1 and left eye 104-2, through a matrix of light guides 206 (FIG. 2) (e.g., a lenticular lens, a parallax barrier, etc.) that cover the surface of display 304. In one implementation, light guide 206-x may dynamically change the directions in which the light rays are emitted from the surface of display 304, depending on input from device 102.

Control buttons 306 may permit the user to interact with device 102 to cause device 102 to perform one or more operations, such as place or receive a telephone call. Keypad 308 may include a standard telephone keypad. Microphone 310 may receive audible information from the user.

Sensors 312 may collect and provide, to device 102, information (e.g., acoustic, infrared, etc.) that is used to aid viewer 104 in capturing images (e.g., for providing information for auto-focusing to lens assembly 314) and/or to track viewer 104. In one implementation, sensor 312 may provide the distance and the direction of viewer 104 from device 102, so that device 102 may determine two-dimensional (2D) projections of virtual 3D objects onto display 304. Examples of sensors 312 include an ultrasound sensor, an infrared sensor, a camera sensor, a heat detector, etc. that may obtain viewer 104's position/location.

Lens assembly 314 may include a device for manipulating light rays from a given or a selected range, so that images in the range can be captured in a desired manner. Housing 316 may provide a casing for components of device 102 and may protect the components from outside elements.

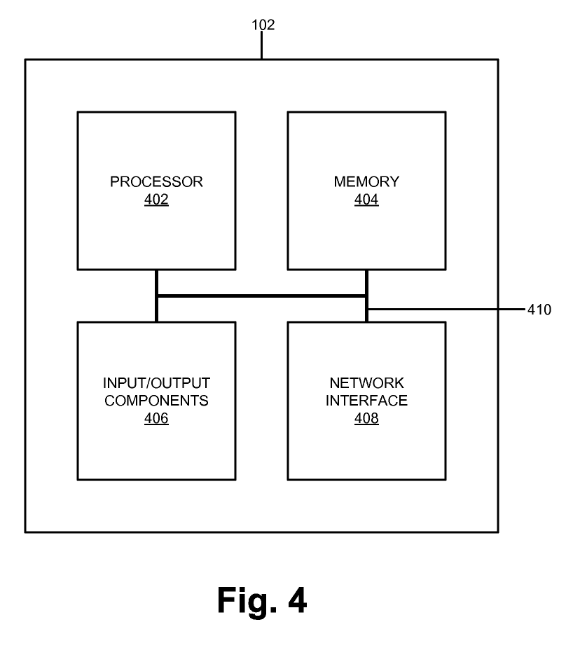

FIG. 4 is a block diagram of a device 102. As shown, device 102 may include a processor 402, a memory 404, input/output components 406, a network interface 408, and a communication path 410. In different implementations, device 102 may include additional, fewer, or different components than the ones illustrated in FIG. 4.

Processor 402 may include a processor, a microprocessor, an Application Specific Integrated Circuit (ASIC), a Field Programmable Gate Array (FPGA), and/or other processing logic capable of controlling device 102. In one implementation, processor 402 may include components that are specifically designed to process 3D images. Memory 404 may include static memory, such as read only memory (ROM), and/or dynamic memory, such as random access memory (RAM), or onboard cache, for storing data and machine-readable instructions. Memory 404 may also include storage devices, such as a floppy disk, CD ROM, CD read/write (R/W) disc, and/or flash memory, as well as other types of storage devices.

Input/output components 406 may include a display (e.g., display 304), a keyboard (e.g., keypad 308), a mouse, a speaker (e.g., speaker 302), a microphone (e.g., microphone 310), a Digital Video Disk (DVD) writer, a DVD reader, Universal Serial Bus (USB) lines, and/or other types of components for converting physical events or phenomena to and/or from digital signals that pertain to device 102.

Network interface 408 may include any transceiver-like mechanism that enables device 102 to communicate with other devices and/or systems. For example, network interface 408 may include mechanisms for communicating via a network, such as the Internet, a terrestrial wireless network (e.g., a WLAN), a satellite-based network, a WPAN, etc. Additionally or alternatively, network interface 408 may include a modem, an Ethernet interface to a LAN, and/or an interface/connection for connecting device 102 to other devices (e.g., a Bluetooth interface).

Communication path 410 may provide an interface through which components of device 102 can communicate with one another.

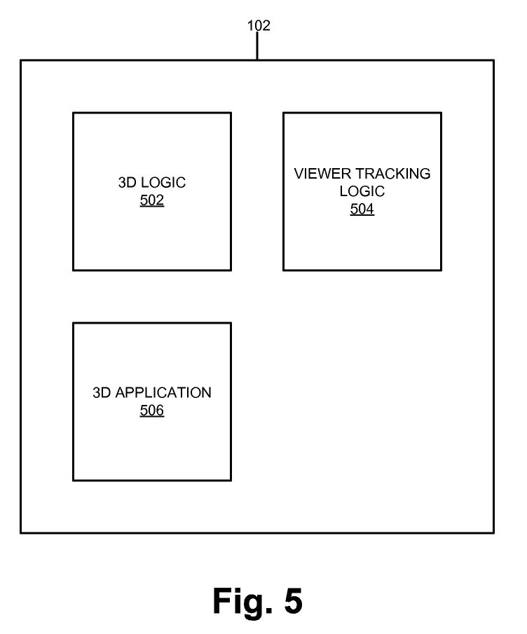

FIG. 5 is a functional block diagram of device 102. As shown, device 102 may include 3D logic 502, viewer tracking logic 504, and 3D application 506. Although not illustrated in FIG. 5, device 102 may include additional functional components, such as the components that are shown in FIG. 4, an operating system (e.g., Symbian OS, Palm OS, Windows Mobile OS, Blackberry OS, etc.), an application (e.g., an instant messenger client, an email client, etc.), etc.

3D logic 502 may include hardware and/or software components for obtaining right-eye images and left-eye images and/or providing the right/left-eye images to a 3D display (e.g., display 304). In some implementations, 3D logic 502 may obtain right- and left-eye images from stored media content (e.g., a 3D movie).

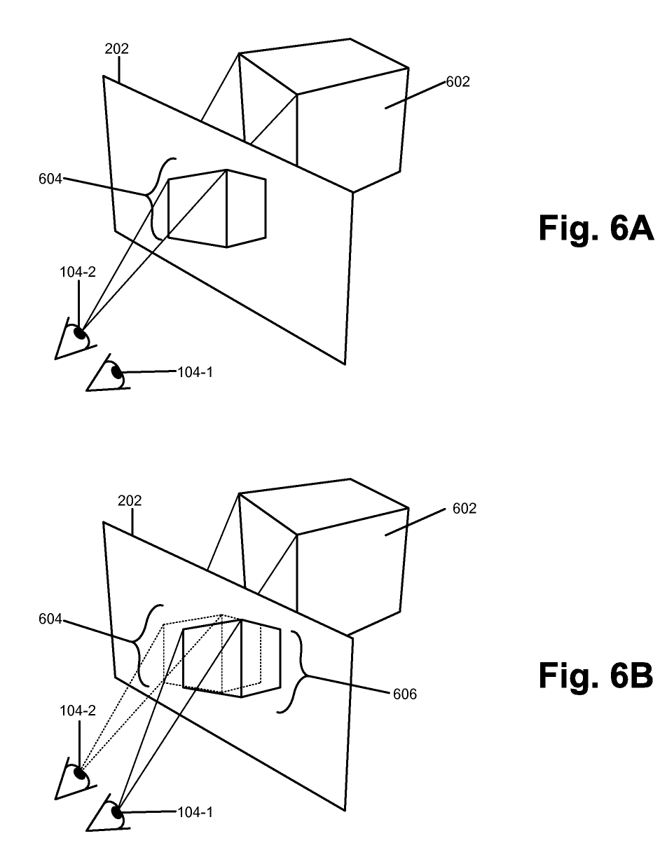

In other implementations, 3D logic 502 may generate the right and left-eye images of a 3D object for different sub-pixels. In such instances, device 102 may obtain projections of the 3D object onto 3D display 202. FIG. 6A shows an exemplary projection of a 3D object 602 onto 3D display 202 for left eye 104-2. Even though 3D object 602 is illustrated as a cube in FIG. 6A, 3D object 602 may correspond to any virtual object (e.g., a representation of an object) within memory 404 of device 102.

In projecting 3D object 602 onto 3D display 202, device 102 may determine, for each point on the surface of 3D object 602, a pixel on display 202 through which a ray from the point would reach left eye 104-2 and determine parameters that may be set for the pixel to emit a light ray that would appear as if it were emitted from the point. For device 102, a set of such parameters for pixels in a viewable area within the surface of 3D display 202 may correspond to a left-eye image.

Once the left-eye image is determined, device 102 may display the left-eye image on 3D display 202. To display the left-eye image, device 102 may select, for each of the pixels in the viewable area, a sub-pixel whose emitted light will reach left eye 104-2. When device 102 sets the determined parameters for the selected sub-pixel within each of the pixels, left eye 104-2 may perceive the left-eye image as image 604 on the surface of 3D display 202. Because light rays from the selected sub-pixels do not reach right eye 104-1, right eye 104-1 may not perceive image 604.

FIG. 6B shows an exemplary projection of 3D object 602 onto 3D display 202 for right eye 104-1. Device 102 may generate image 606 and show image 606 to right eye 104-1 in a manner similar to that for image 604. When right eye 104-1 and left eye 104-2 see images 606 and 604, respectively, viewer 104 may perceive a stereoscopic or 3D image.

Returning to FIG. 5, viewer tracking logic 504 may include hardware and/or software for tracking viewer 104 and/or part of viewer 104 (e.g., head, eyes, etc.) and providing the location/position of viewer 104 to 3D logic 502. In some implementations, viewer tracking logic 504 may include sensors (e.g., sensors 312) and/or logic for determining a location of viewer 104's head or eyes based on sensor inputs (e.g., distance information from more than three sensors, an image of a face, an image of eyes 104-1 and 104-2, etc.).

3D application 506 may include hardware and/or software that may show 3D images on 3D display 202. In showing the 3D images, 3D application may use 3D logic 502 and/or viewer tracking logic 504 to generate 3D images and/or provide the 3D images to 3D display 202. Examples of 3D application may include a 3D graphics game, a 3D movie player, etc.

### Exemplary Process for Displaying 3D Views Based on Viewer Tracking

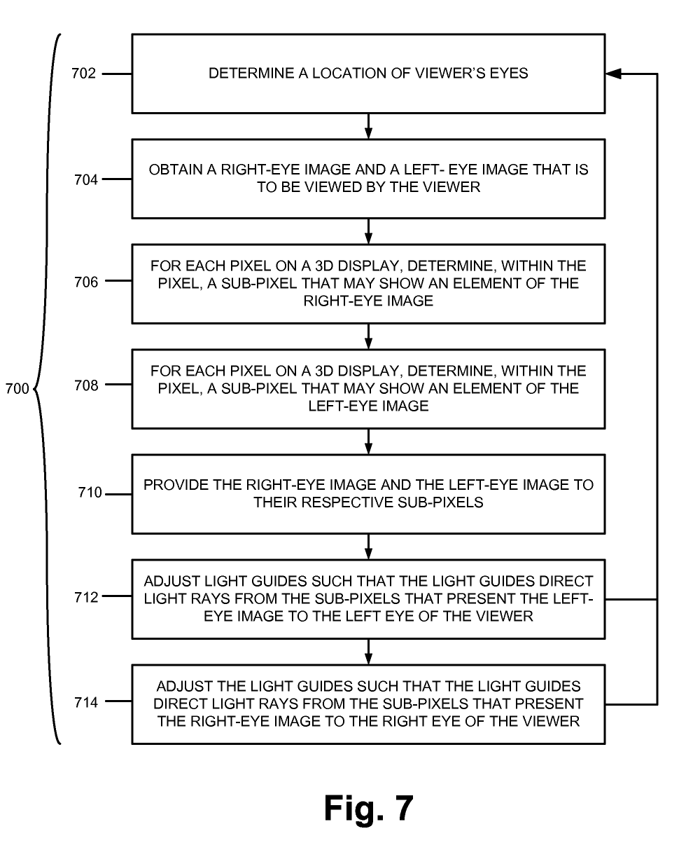

FIG. 7 is flow diagram of an exemplary process 700 for displaying 3D images based on viewer tracking. Process 700 may start at block 702, where viewer tracking logic 504 may locate viewer 104's eyes. Locating the eyes may entail, for example, tracking viewer 104 or viewer 104's eyes 104-1 and 104-2.

A component in device 102 may obtain a right-eye image and a left-eye image that are to be viewed at viewer 104's location (block 704). In one implementation, 3D logic 502 may retrieve pre-generated images from multimedia content in memory 404 (e.g., a 3D movie). If device 102 tracks multiple viewers, 3D logic 502 may select only images that the tracked viewers can see at locations that are determined at block 702. In another implementation, 3D logic 502 may generate the right-eye and left-eye images based on viewer 104's location, for example, by projecting a virtual 3D object stored in memory 404 onto 3D display 202.

3D logic 502 may determine, for each pixel on 3D display 202, a sub-pixel that may show an element of the right-eye image (block 706). For example, assume that a set of pixels on 3D display 202 will show a 3D image. For each pixel in the set, 3D logic 502 may select, within the pixel, a sub-pixel whose light ray will reach viewer 104's right eye. In some implementations, if the distance of 3D display from viewer 104 is large compared to dimensions of 3D display 202, 3D logic may select sub-pixels whose light rays are in the same direction (e.g., second sub-pixel within each of the pixels).

3D logic 502 may determine, for each pixel on 3D display 202, a sub-pixel that may show an element of the left-eye image (block 708).

3D logic 502 may provide the right-eye image and the left-eye image at their respective sub-pixels (block 710). The mechanisms that are involved in providing or showing the images may depend on the particular implementation of device 102. For example, in one implementation, when 3D application 506 invokes an application programming interface (API) that sends a right-eye image, a left-eye image, and a location of viewer 104 to 3D logic 502 (e.g., a graphics card driver and the graphics card combination), 3D logic 502 may send images to their respective sub-pixels.

In another implementation in which device 102 is provided with information that describes a virtual 3D object, 3D logic 502 may determine the projections of the 3D virtual objects onto 3D display 202 for the right-eye and the left eye of viewer 104. 3D logic 502 may then send the images to the respective sub-pixels.

In some implementations, light guides 206 may be capable of changing or adjusting light guides 206 to direct light rays from the sub-pixels that show the left-eye image to the left eye of viewer 104 (block 712). In addition, 3D logic 502 may adjust light guides 206 to direct light rays from the sub-pixels that show the right-eye image to the right eye of viewer 104 (block 714).

At blocks 712 or 714, process 702 may return to block 702 to continue to display images in accordance with viewer 104's position.

### Alternative Implementation

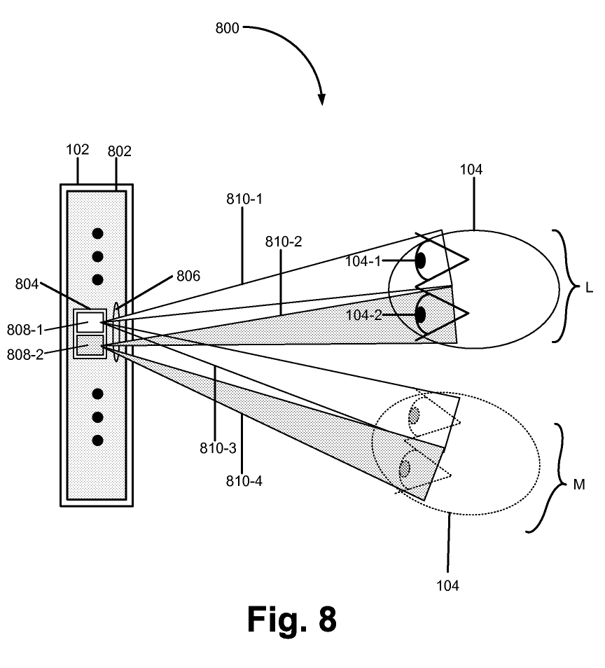

FIG. 8 is a diagram illustrating operation of alternative implementation of the device of FIG. 1. As shown, device 102 may include 3D display 802. As further shown, 3D display 802 may include pairs of pixels and light guides, a pair of which is illustrated as pixel 804 and light guide 806. In this implementation, pixel 804 may include sub-pixels 808-1 and 808-2.

In FIG. 8, sub-pixels 808-1 and 808-2 may emit light rays 810-1 and 810-2 to provide viewer 104 with a stereoscopic or 3D image. When viewer 104 moves from location L to location M, based on viewer tracking, device 102 may obtain or generate a new 3D image for viewer 104 at location M, and cause light guide 806 to direct light rays 810-3 and 810-4 from sub-pixels 808-1 and 808-2 to viewer 104. In addition, device 104 may control light guide 806 to guide light rays 810-3 and 810-4 to reach right and left eyes 104-1 and 104-2 of viewer 104 at location M. Consequently, viewer 104 may perceive the new 3D image that is consistent with location M. That is, viewer 104 may view the 3D image at new location M.

In the above implementation, the number of sub-pixels is illustrated as two. However, depending on the number of viewers that display 802 is designed to concurrently track and support, display 802 may include additional pairs of sub-pixels. In such implementations, with additional sub-pixels, device 102 may obtain or generate additional images for the viewers at various locations.

In some implementations, the number of viewers that device 102 can support with respect to displaying 3D images may be greater than number of sub-pixels/2 within each pixel. For example, device 102 in FIG. 8 may track and provide images for two viewers, which is greater than two pixels/2=1. In such an instance, device 102 may alternate stereoscopic images on display 802, such that each viewer perceives a continuous, coherent 3D image. Light guide 806 may be synchronized to the rate at which device 102 switches the stereoscopic images, to direct light rays from one of the stereoscopic images to a corresponding viewer at proper times.

### EXAMPLE

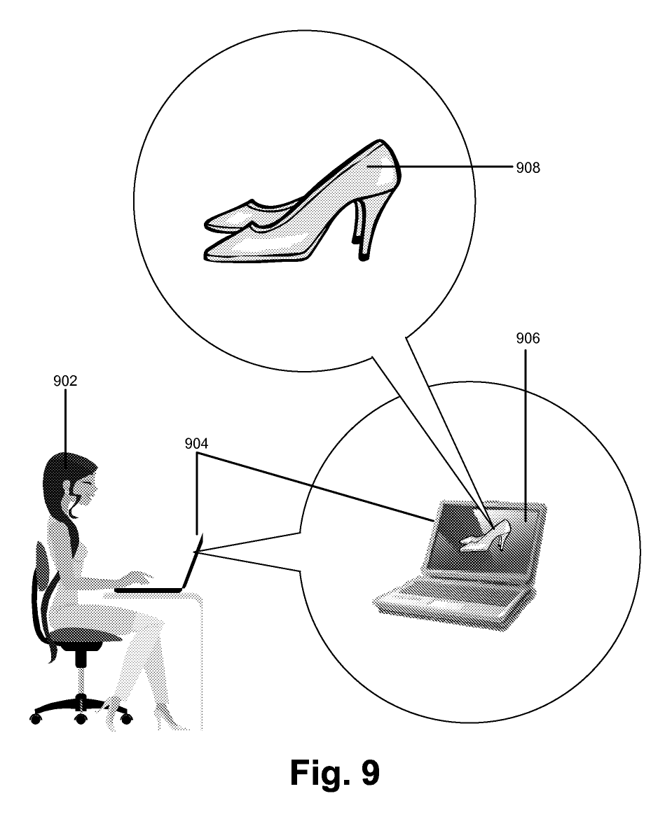

The following example, with reference to FIG. 9, illustrates above described process 700. In the example, Judy 902 is at her home office with a laptop 904 with a 3D display 906. Judy 902 is shopping at an online shoe store, and is viewing different types of shoes. When Judy 902 sees a particular brand of shoes 908 that she likes, she requests a 3D image of shoes 908 via a browser installed in her laptop. Judy 902 downloads a 3D model of shoes 908.

Laptop 904 determines a location of Judy's eyes by tracking Judy's head, obtains 2D projections of shoes 908 to obtain right-eye and left-eye images, and provides the right-eye and left-eye images via different sets of sub-pixels to Judy's right eye and left eye. Consequently, Judy 902 sees a 3D image of shoes 908.

As Judy 902 moves her head or changes position to examine shoes 908 from different angles, viewer tracking logic 504 in laptop 904 tracks Judy's head, and 3D application 506 continuously generates new 3D images for her right-eye and left-eye. Judy 902 is therefore able to view and evaluate shoes 908 from different angles as Judy moves.

In the above example, a device may track a viewer and generate 3D images based on the viewer's location at a particular time. By generating/determining 3D images based on the viewer's location, the device may need/use less computing cycles, power, and amount of memory than that may be required if the device were to pre-compute and provide the images for a number of different viewing positions.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

In the above, while a series of blocks has been described with regard to exemplary processes 700 illustrated in FIG. 7, the order of the blocks in processes 700 may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the implementations described herein unless explicitly described as such. Also, as used herein, the article “a” is intended to include one or more items. Where one item is intended, the term “one” or similar language is used. Further, the phrase “based on” is intended to mean “based, at least in part, on” unless explicitly stated otherwise.

What is claimed is:

1. A method comprising:
tracking one or more viewers;
determining, for each of the one or more viewers, a location of the viewer in accordance with the tracking;
determining, for each of the one or more viewers, a stereoscopic image that is to be viewed by the viewer at the location, the stereoscopic image consisting of a right-eye image and a left-eye image; and
controlling display settings of a display to provide, via the display, each of the one or more viewers with the stereoscopic image associated with the viewer.

2. The method of claim 1, further comprising:
providing, via the display, each of the one or more viewers with the stereoscopic image associated with the viewer.

3. The method of claim 1, where tracking includes:
tracking a head of each of the one or more viewers to determine a location of a right eye of the head.

4. The method of claim 3, where tracking one or more viewers includes:
tracking two viewers.

5. The method of claim 1, where determining a stereoscopic image includes:
determining a projection of a virtual, three-dimensional object, which is stored in a memory of a device, onto a surface of the display, to obtain the right-eye image; or
obtaining the right-eye image from stored, three-dimensional multimedia content.

6. The method of claim 1, where controlling display settings includes:
adjusting a light guide to direct light rays from a picture element of the right-eye image on a surface of the display to the right eye and not to the left eye.

7. The method of claim 1, further comprising:
displaying, on the display, the right-eye image via a first set of sub-pixels that are visible to the right eye, and the left-eye image via a second set of sub-pixels that are visible to the left eye.

8. The method of claim 1, further comprising:
displaying, on the display, the right-eye image via sub-pixels;
directing light rays from the sub-pixels to the right eye;
displaying, on the display, the left-eye image via the sub-pixels; and
directing light rays from the sub-pixels to the left-eye.

9. The method of claim 1, further comprising:
displaying, on the display, one of a plurality of stereoscopic images via sub-pixels;
directing light rays from the sub-pixels to a first one of the viewers and not other ones of the viewers;
displaying, on the display, another one of the plurality of stereoscopic images via the sub-pixels; and
directing light rays from the sub-pixels to a second one of the viewers and not other ones of the viewers.

10. A device comprising:
a sensor for tracking a viewer;
a display including pixels and light guides, each light guide configured to direct light rays from a first sub-pixel within a pixel and a second sub-pixel within the pixel to a right eye and a left eye, respectively, of the viewer; and
a processor to:
obtain a location of the viewer based on output of the sensor;
determine a stereoscopic image that is to be viewed at the location, the stereoscopic image consisting of a right-eye image and a left-eye image; and
display the right-eye image for viewing by the right eye via a first set of sub-pixels and the left-eye image for viewing by the left eye via a second set of sub-pixels.

11. The device of claim 10, where the processor is further configured to:
drive the display to provide the stereoscopic image to the viewer when the stereoscopic image is displayed on the display.

12. The device of claim 10, where the device comprises at least one of:
a laptop;
a cell phone;
a personal computer;
a personal digital assistant; or
a game console.

13. The device of claim 10, where the sensor includes at least one of:
an ultrasonic sensor;
an infrared sensor;
a camera sensor; or
a heat sensor.

14. The device of claim 10, where the light guide includes:
a lenticular lens; or
a parallax barrier.

15. The device of claim 14, where the parallax barrier is configured to:
modify a direction of a light ray from the first sub-pixel based on the location of the viewer.

16. The device of claim 10, where the right-eye image includes:
an image obtained from three-dimensional multimedia content; or
a projection of a three-dimensional virtual object onto the display.

17. The device of claim 10, where the light guide is further configured to:
redirect light rays from the first sub-pixel to the left eye of the viewer when a new image element is displayed by the first sub-pixel.

18. The device of claim 10, where the light guide is further configured to:
redirect light rays from the second sub-pixel to a left eye of another viewer when a new image element is displayed by the second sub-pixel.

19. The device of claim 10, where the sensor includes:
a mechanism for locating the left eye and the right eye of the viewer.

20. A device comprising:
means for tracking a head of a viewer;
means for displaying three-dimensional images;
means for obtaining a location of the viewer based on output of the means for tracking the head;
means for obtaining a three-dimensional image that is to be viewed at the location; and
means for displaying the three-dimensional image.
